(19) United States
(12) Patent Application Publication
(10) Pub. No.: US 2002/0182946 A1
(43) Pub. Date: Dec. 5, 2002

(54) Power generation plant ship

(76) Inventor: Eitaro Tanaka, Tokyo (JP)

Correspondence Address: LOWE HAUPTMAN GOPSTEIN GILMAN & BERNER, LLP, 1700 Diagonal Road, Suite 310, Alexandria, VA, 22314, US

(21) Appl. No.: 09/865,495

(22) Filed: May 29, 2001

(51) Int. Cl. B60L 11/02

(52) U.S. Cl. 440/6

(57) ABSTRACT

A power generation plant ship (1) of the present invention having a body (2) with a propulsion mechanism (7) includes a solar power generation system (3), a wind power generation system (4) for obtaining electric energy by driving a generator by rotating a windmill (4a) by receiving wind power, and a storage battery (6) for storing the electric energy generated by the respective power generation systems (3, 4).

### BACKGROUND OF THE INVENTION

1. Field of the Invention

The present invention relates to a power generation plant ship. More specifically, it relates to a power generation plant ship which sails in accordance with seasons, weather etc. to a place where sunlight can be most effectively received or a place where wind force is strong for generating electrical power from the sunlight and the wind force etc.

2. Description of Related Art

Recently, in accordance with increase in energy consumption, global environmental pollution has become a problem, and alternative energy in place of the presently used fossil fuel such as petroleum has been increasingly required.

At present, as one of arts for common clean alternative energy, an art to transform solar energy into electric energy by solar battery is known. The art has been made into practical use. Further, stored hydrogen is one of expected alternative energy sources. The energy is obtained by storing compressed hydrogen gas and using the hydrogen in a fuel cell or a hydrogen engine, or as various heat sources. Hydrogen couples with oxygen to become water when it is burned, and emits no toxic gas. Further, hydrogen is exhaustless, since it can be obtained by electrolyzing water.

The art to obtain hydrogen gas using solar battery is disclosed in Japanese Patent Laid-open Publication No. 55-116601, in which a solar battery is placed on the water to freshen seawater by electric energy obtained by transforming sunlight by the solar battery. The hydrogen gas is generated by electrolyzing the fresh water, which is stored as gas, liquid or solid.

A solar power generation system may preferably move to the most suitable place in accordance with weather etc., since the system utilizes sunlight as energy source and quantity of the sunlight incident on the solar battery varies in accordance with places, weather etc.

In the above-mentioned prior hydrogen gas generation system that uses the solar battery, the solar battery is disposed on the sea around the equator. However, the system cannot move by itself and the battery keeps on the place.

Therefore, the solar power generation system itself cannot receive the sunlight and generate power during the night or in the rain etc.

### SUMMARY OF THE INVENTION

The present invention has been invented by considering the above situation, and an object of the present invention is to provide a power generation plant ship capable of generating power irrespective of conditions such as night and rain.

The present invention takes the following means to solve the problem.

Specifically, as shown in FIG. 1, a power generation plant ship according to the present invention has a body 2 with a propulsion mechanism 7, including a solar power generation system 3 for transforming sunlight into electric energy, a wind power generation system 4 having windmills 4a rotated by receiving wind force for driving a generator to obtain electric energy, and a storage battery 6 for storing the electric energy generated by the respective power generation systems 3, 4.

In the present invention, the solar power generation system 3 works by receiving the sunlight, and the wind power generation system 4 works by receiving the wind force during the daytime. On the other hand, the wind power generation system 4 mainly generates power during the night or in the rain etc. Accordingly, the electric power can be obtained by effectively working the respective power generation systems. Further, the power generation plant ship 1 of the present invention can sail on the sea, so that the ship can move to a place where the sunlight can be most effectively received and a place where the wind power is strong enough for generating power.

Further, according to another aspect of the present invention, the electric energy can be stored not only in the storage battery 6, but also as energy transformed from the electric energy and stored in hydrogen gas (or compressed liquid hydrogen). Namely, as shown in FIG. 4, the above aspect of the present invention has a body 2 with a propulsion mechanism 7, including a solar power generation system 3 for transforming sunlight into electric power, a wind power generation system 4 having a windmill 4a rotated by receiving wind power for driving a generator to obtain electric energy, a seawater-freshening system 9 for freshening seawater to obtain fresh water, an electrolysis system 10 for electrolyzing the fresh water to obtain hydrogen and oxygen, and a hydrogen storage 11 for storing the hydrogen obtained by electrolyzing the fresh water, the freshening and the electrolysis of the fresh water being carried out by the electric energy generated by the respective power generation systems 3, 4.

In this arrangement, the hydrogen is stored as gas, liquid etc. The stored hydrogen may preferably be transformed into electric energy by a fuel cell, and be used for a hydrogen engine or as various heat sources.

Though the above aspect of the present invention stores the electric energy itself or as energy stored in hydrogen gas, the power generation plant ship according to the present invention may have a storage battery 6 for storing the electric energy generated by the solar power generation system 3 and the wind power generation system 4.

In this arrangement, the present invention can store two energy sources, i.e. the electric energy and the hydrogen.

Alternatively, the power generation plant ship 1 may have a thermal power generation system 5 for obtaining the electric energy by driving a generator with thermal energy generated by burning fossil fuel and industrial wastes.

In this arrangement, the electric energy can be obtained by the thermal power generation. In addition, a problem of exhaust gas occurred by the thermal power generation and burning wastes at a residential area can be solved.

Further, the present invention may preferably have the propulsion mechanism 7 driven by the electric energy obtained by the respective power generation systems.

Furthermore, in the present invention, the electric energy generated by the power generation systems may be transmitted from a sea base 21 to a land base 23 via submarine cable 22 connecting the sea base 21 with the land base 23.

In this arrangement, the sea base 21 may be constructed, for example, around an equatorial area or in an area with strong wind, so that the electric energy can be transmitted from the sea base 21 to the land base 23 without returning to the land base. The submarine cable 22 may be lead-coated cable or superconducting cable, for example.

Further, in the present-invention, the hydrogen and/or the oxygen obtained by the electrolysis system 10 may be transmitted from the sea base 21 to the land base 23 via a transmitting system 22 connecting the sea base 21 with the land base 23.

In this arrangement, the sea base 21 may be constructed, for example, around an equatorial area or in an area with strong wind, so that the hydrogen and/or the oxygen can be transmitted from the sea base 21 to the land base 23 without returning to the land base. The transmitting system 22 may be a pipe, for example.

### BRIEF DESCRIPTION OF THE DRAWINGS

FIG. 1 is a general front elevational view showing first embodiment of the present invention;

FIG. 2 is a block diagram showing primary structure of the first embodiment of the present invention;

FIG. 3 is a perspective view showing general structure of the first embodiment of the present invention;

FIG. 4 is a block diagram showing second embodiment of the present invention;

FIG. 5 is a block diagram showing third embodiment of the present invention; and

FIG. 6 is a general front elevational view showing fourth embodiment of the present invention.

### DETAILED DESCRIPTION OF PREFERRED EMBODIMENT(S)

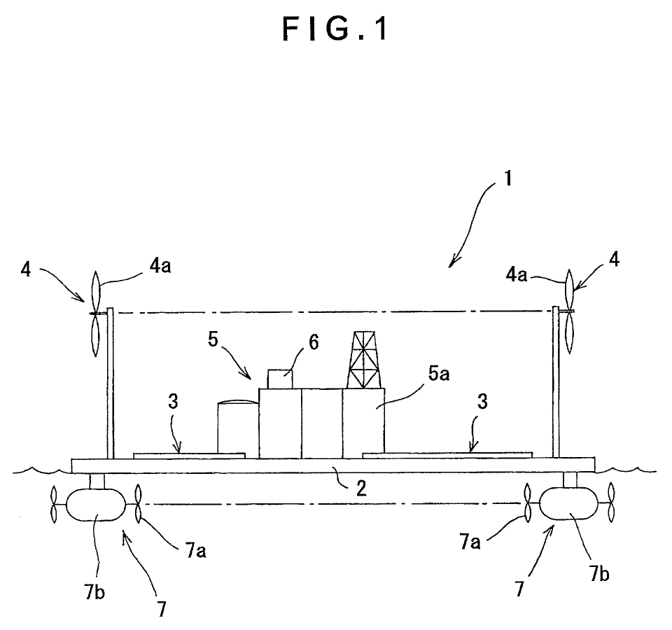

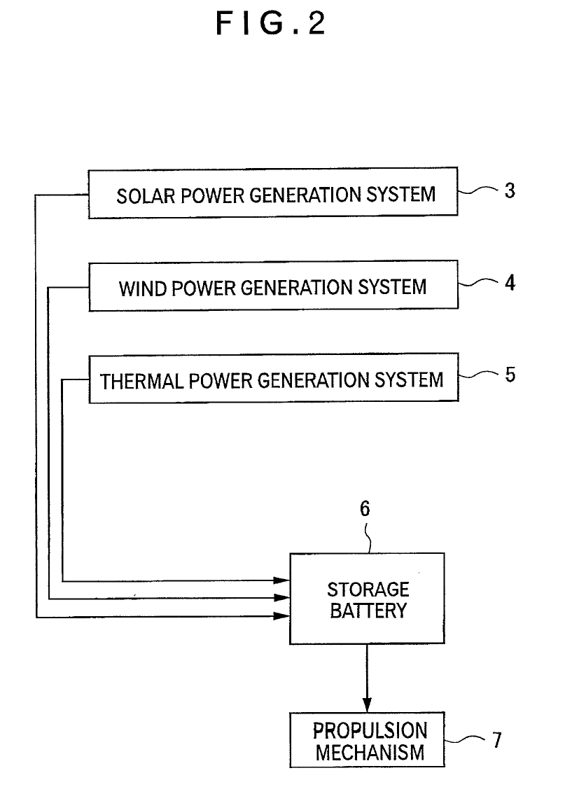

A first embodiment of the present invention will be described below with reference to FIGS. 1-3.

A power generation plant ship 1 according to the present embodiment of the present invention has a platform body 2 including a solar power generation system 3, a wind power generation system 4, a thermal power generation system 5, a storage battery 6, and a propulsion mechanism 7. The solar power generation system 3 has a solar battery 3a covering a wide range of the upside of the body 2 and transforming received sunlight into electric energy. The wind power generation system 4 has a plurality of windmills 4a disposed on periphery of the upside of the body 2, the windmills rotating by receiving wind force to drive a generator and generate electric energy.

The thermal power generation system 5 has thermal power generation equipment 5a provided substantially at the center of the body 2. The thermal power generation system 5 generates electric energy by driving a generator with thermal energy generated by burning fossil fuel or industrial wastes.

The propulsion mechanism 7 has propulsors 7b including screws 7a. The propulsors 7b are mounted on both sides of the downside of the body 2. The screws 7a are rotated by the electric energy obtained by the respective power generation systems 3, 4 and 5, and propel the body 2.

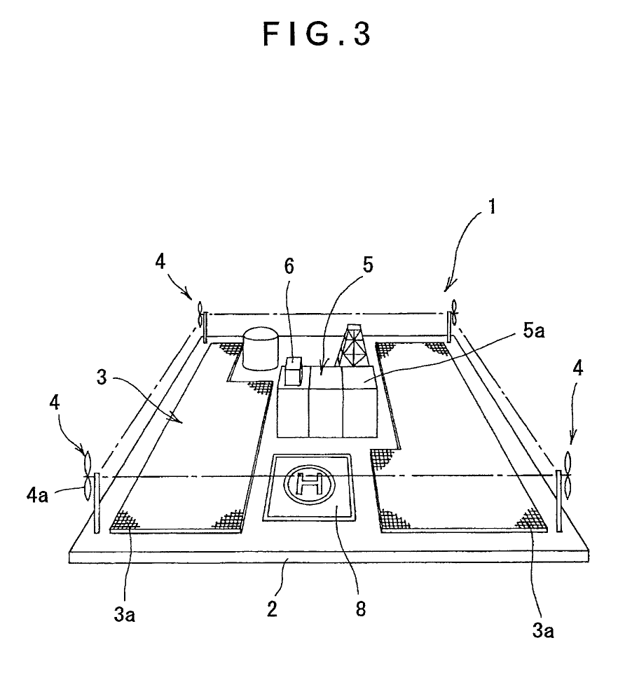

In this embodiment, propulsion direction of the body 2 can be controlled by changing directions of the propulsors 7b. Further, as shown in FIG. 3, the body 2 has a heliport 8 used for transporting a crew, in case of emergency etc.

The power generation plant ship 1 of the present invention sails to an area where sunshine hours are long and the wind is strong such as the sea around the equator. The solar power generation system 3 and the wind power generation system 4 are driven by receiving strong sunlight and wind force during the daytime. On the other hand, only the wind power generation system 4 is driven during the night, in the rain etc. Accordingly, the electric energy can be effectively obtained by the solar power generation system 3 and the wind power generation system 4 in the present invention.

On the other hand, the thermal power generation system 5 generates electric energy by driving a generator with thermal energy generated by burning fossil fuel or industrial wastes. The electric energy generated by the respective power generation systems 3, 4 and 5 is stored in the storage battery 6. As described above, the power generation plant ship 1 of the present invention sails in accordance with seasons, weather etc. to a place where the sunlight can be effectively received or a place where the wind force is strong for effectively driving the respective power generation systems 3, 4 and 5 to generate electrical power.

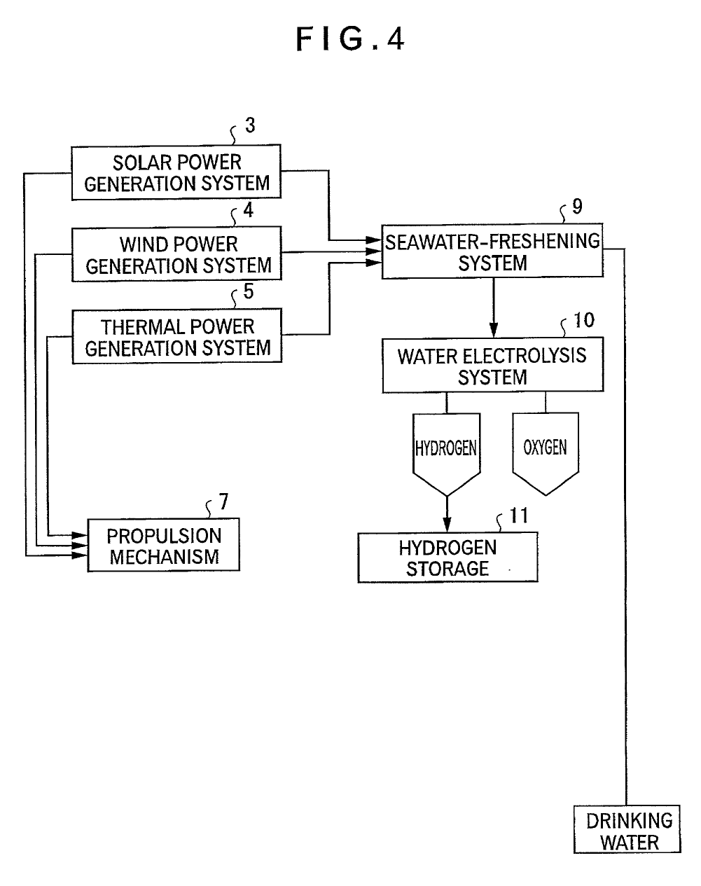

Next, a second embodiment of the present invention will be described below with reference to FIG. 4.

While the aforesaid first embodiment stores the electric energy obtained by the respective power generation systems 3, 4 and 5 in the storage battery 6, the second embodiment stores the electric energy obtained by the respective power generation systems 3, 4 and 5 after transforming into hydrogen.

Specifically, the present embodiment freshens seawater by a freshening system 9 such as seawater-freshening equipment using a method such as an ion-exchange method, and using the electric energy obtained by the solar power generation system 3, the wind power generation system 4 and the thermal power generation system 5. The fresh water is decomposed into hydrogen and oxygen by a water electrolysis system 10 such as electrolyzed hydrogen/oxygen gas producing equipment. The hydrogen is stored in a hydrogen storage 11. The hydrogen storage 11 stores the hydrogen as gas or liquid by liquid hydrogen producing equipment etc., or alternatively stores the hydrogen in hydrogen-storing alloy. The generated oxygen may be stored and used for a fuel cell or burning etc. A part of the fresh water can be used as drinking water.

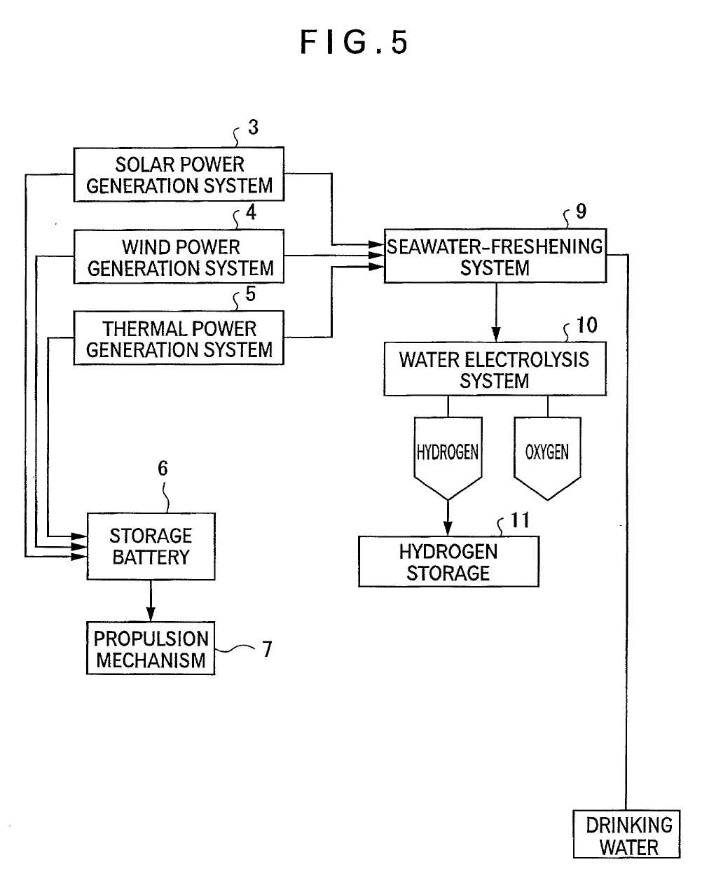

Next, a third embodiment of the present invention will be described below with reference to FIG. 5.

The third embodiment further includes a storage battery 6 for storing electric energy in addition to the arrangement shown in FIG. 4.

Specifically, in this embodiment, the electric energy obtained by the solar power generation system 3, the wind power generation system 4 and the thermal power generation system 5 is stored in the storage battery 6 as well as stored in the hydrogen storage 11 as energy transformed from the electric energy and stored in hydrogen.

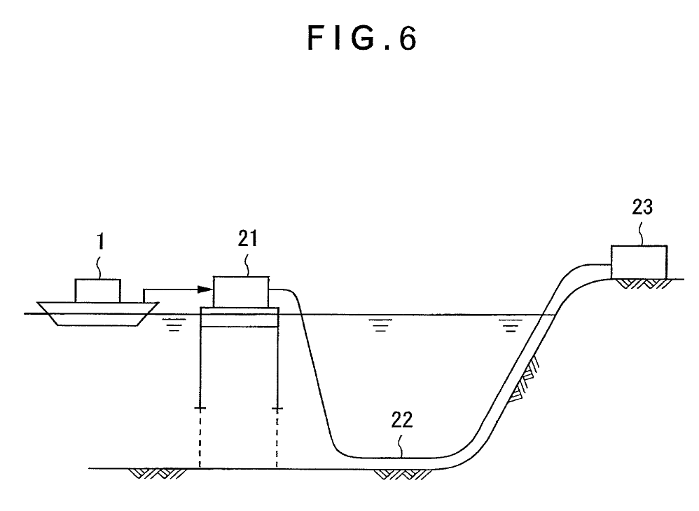

Next, a fourth embodiment of the present invention will be described below with reference to FIG. 6.

The embodiment shown in FIG. 6 has the electric energy, the hydrogen and the oxygen stored in the power generation plant ship 1 and transmitted from a transmitting installation of a sea base 21 constructed on the sea to a receiving installation of a land base 23 constructed on land via submarine cable 22 for the electric energy (a pipe 22 for the hydrogen and the oxygen). Accordingly, time and energy for the power generation plant ship 1 to transport the electric energy, the hydrogen and the oxygen to the land base 23 can be omitted. Further, the power generation plant ship 1 can freely sail on the sea, so that the ship 1 can generate power under more preferable condition than a case that only the sea base 21 generates power.

The submarine cable 22 may be lead-coated cable or superconducting cable, for examples.

Incidentally, the scope of the present invention is not restricted to the above respective embodiments, but includes modifications and improvements as long as an object of the present invention can be achieved.

For instance, an installation of the solar battery is not restricted to zero degree relative to the upside of the body (i.e. parallel with the upside of the body), but may be changed in accordance with an incident angle of the sunlight by a system changing the angle of the solar battery.

The number of the windmills and a setting place therefor are changeable as desired.

Further, fuel of the thermal power generation system is not restricted to the fossil fuel and the industrial wastes, but may be synthethic fuel etc.

What is claimed is:

1. A power generation plant ship having a body with a propulsion mechanism, comprising:
a solar power generation system for transforming sunlight into electric energy;
a wind power generation system having a windmill rotated by receiving wind power for driving a generator to obtain electric energy; and
a storage battery for storing the electric energy generated by the power generation systems.

2. A power generation plant ship having a body with a propulsion mechanism, comprising:
a solar power generation system for transforming sunlight into electric energy;
a wind power generation system having a windmill rotated by receiving wind power for driving a generator to obtain electric energy;
a freshening system for freshening seawater to obtain fresh water;
an electrolysis system for electrolyzing the fresh water to obtain hydrogen and oxygen; and
a hydrogen storage for storing the hydrogen obtained by electrolyzing the fresh water;
wherein the freshening and the electrolysis of the fresh water are carried out by the electric energy generated by at least one of the power generation systems.

3. The power generation plant ship according to claim 2, further comprising:
a storage battery for storing the electric energy generated by the solar power generation system and the wind power generation system.

4. The power generation plant ship according to claim 1, further comprising:
a thermal power generation system for obtaining electric energy by driving a generator with thermal energy generated by burning fossil fuel and/or industrial wastes.

5. The power generation plant ship according to claim 2, further comprising:
a thermal power generation system for obtaining electric energy by driving a generator with thermal energy generated by burning fossil fuel and/or industrial wastes.

6. The power generation plant ship according to claim 1, comprising:
a propulsion mechanism driven by the electric energy obtained by the power generation systems.

7. The power generation plant ship according to claim 2, comprising:
a propulsion mechanism driven by the electric energy obtained by the power generation systems.

8. The power generation plant ship according to claim 1, wherein the electric energy generated by the power generation systems can be transmitted from a sea base to a land base via submarine cable connecting the sea base with the land base.

9. The power generation plant ship according to claim 2, wherein the electric energy generated by the power generation systems can be transmitted from a sea base to a land base via submarine cable connecting the sea base with the land base.

10. The power generation plant ship according to claim 2, wherein the hydrogen and/or the oxygen obtained by the electrolysis system can be transmitted from a sea base to a land base via a transmitting system connecting the sea base with the land base.
